(19) United States
(12) Patent Application Publication
(10) Pub. No.: US 2017/0110922 A1
(43) Pub. Date: Apr. 20, 2017

(54) ELECTRIC MACHINE AND METHOD, AND USE THEREOF

(71) Applicant: Robert Bosch GmbH, Stuttgart (DE)

(72) Inventor: Ruediger Schroth, Renningen-Malmsheim (DE)

(73) Assignee: Robert Bosch GmbH, Stuttgart (DE)

(21) Appl. No.: 15/315,893

(22) PCT Filed: Jun. 3, 2015
(86) PCT No.: PCT/EP2015/062326

§ 371 Date: Dec. 2, 2016

(30) Foreign Application Priority Data
Jun. 5, 2014 (DE) 102014210692.3

(51) Int. Cl. H02K 3/20; H02K 15/06; H02K 1/14; F02N 11/04; H02K 1/04; H02K 7/00

(52) U.S. Cl. CPC H02K 3/20; H02K 1/04; H02K 7/006; H02K 1/145; F02N 11/04; H02K 15/06

(57) ABSTRACT

The subject matter of the present invention relates to an electric machine (10) for converting mechanical energy into electrical energy or vice-versa, in particular a generator such as a Lundell alternator and/or a belt-driven starter generator, having at least two conductive components with a magnetic flux therebetween during conversion, in particular having at least one rotor (20) and at least one stator (16) associated therewith, wherein a damping device (100) of the type of a shim (101) is integrally bonded without strain to at least one of the two components, that is to say without strain relative to another component, or between adjacent components, in order to reduce magnetic noise. The invention further relates to a method and to a use thereof.

### BACKGROUND OF THE APPLICATION

The invention relates to an electric machine for converting mechanical energy into electrical energy or vice versa, in particular a generator, such as a claw-pole generator and/or a belt-driven starter generator.

In addition, the invention relates to a method for producing and/or for operating an electric machine for converting mechanical energy into electrical energy or vice versa, in particular a starting device, such as a starter, or a generator, such as a claw-pole generator.

Not least, the invention relates to the use of at least one damping device in the manner of a shim in an electric machine in which mechanical energy is converted into electrical energy or vice versa, in particular in the case of a starting device, such as a starter, or in the case of a generator, such as a claw-pole generator.

The invention is based on an electric machine for converting mechanical energy into electrical energy, or formed reversibly, for converting electrical energy into mechanical energy according to the generic type.

The present invention relates to electric machines, in particular claw-pole generators, for the DC voltage supply of motor vehicle electrical systems.

Generators for converting mechanical energy into electrical energy in the motor vehicle are known from the prior art. The use of generators which are equipped with electrical excitation is customary. Said generators produce alternating currents which are converted via a rectifier into direct current in order to use said current in DC voltage electrical systems of motor vehicles. In motor vehicles, use is made above all of alternating current generators in the form of claw-pole generators for producing energy. A rotor comprises a rotor shaft on which at least one pole core and two claw poles are mounted. During rotation of the rotor shaft or of the rotor, the latter rotates in relation to a stator. The rotor is guided on both sides in rolling bearings by means of end plates. If a direct current flows through an exciting winding in the rotor, a magnetic field is produced. As soon as the rotor rotates, the magnetic field induces an alternating voltage in the stator windings.

The pole core, the two claw poles and generally a spacer disk are pressed onto the rotor shaft in the prior art. For this purpose, the claw poles and the pole core have to be drilled through in the center. Depending on the configuration of the electric machine, especially depending on the number of stator phases and of the claw design, forces are produced which excite the structure of the electric machine to vibrate. This leads to a “magnetic noise”.

JP 2008 048 466-A discloses an electric machine having a damping device designed as a shim. The shim is arranged here between the stator and a motor housing. The shim is fastened here to the motor housing.

Shims are generally known from various documents, for example JP 2010 239725.

### SUMMARY OF THE INVENTION

The electric machine according to the invention, the method according to the invention and the use according to the invention have the advantage over the prior art that, in the case of an electric machine for converting mechanical energy into electrical energy or vice versa, in particular a generator, such as a claw-pole generator and/or a belt-driven starter generator, having at least two conductive components, between which there is a magnetic flux during the conversion, in particular having at least one rotor and at least one associated stator, wherein a damping device in the manner of a shim for reducing a magnetic noise is arranged in an integrally bonded manner on at least one of the two components, preferably on the stator, in particular without clamping, that is to say without clamping with another component, or between adjacent components, a magnetic noise is reduced. Owing to the integrally bonded arrangement, the damping device can easily also be mounted retrospectively. Various embodiments are conceivable here, and therefore the magnetic noise can be gradually reduced. By means of the integrally bonded mounting on the stator, without clamping, i.e. without contact being made with a further component, or else without clamping with another component or between components, for example between the end plate and the stator, being necessary, retrospective mounting is possible on all generators. The shim used may be, for example, a thin sheet, of a thickness approximately within the range of a few millimeters and composed of a metallic material. The sheet can be designed as a fine sheet with a thickness range ≦2.99 mm, as a medium plate with a thickness range ≧3.00 mm to ≦4.75 mm or as a large plate with a thickness range ≧4.76 mm. Fine sheets are preferred. In another embodiment, a metal foil can be provided instead of a sheet/plate or in addition thereto. For use as a shim, the sheet/plate is mounted on the circumference of the stator. The mounting on the stator is preferred since the forces are produced there from the electromagnetic flux. In addition, the stator provides a sufficiently large area for mounting the shim or the shims.

In an embodiment, it is correspondingly provided that the component on which the damping device or the at least one shim is arranged is designed as a stator. In an embodiment, the damping device comprises at least one shim. In a preferred embodiment, the damping device is designed as at least one shim. According to the preferred embodiment, the terms damping device and shim can be used synonymously.

It is provided in a further embodiment that the damping device comprising a shim or designed as a shim is adhesively bonded on the stator by means of at least one adhesive. Silicone rubber is preferably provided as the adhesive. On account of the temperatures prevailing at the stator, a thermally stable adhesive is preferably provided. In particular, an adhesive is provided which is thermally stable for a temperature range ≧75° C., furthermore preferably ≧85° C. and most preferably ≧95° C.

Yet another embodiment makes provision for the damping device or the shim to be of multilayered design, in particular in the form of a multilayered assembly material. The assembly can be premanufactured here and then mounted on the stator. In another embodiment, the shim can be mounted in layers on the stator, wherein a first shim is fastened to the stator. A second shim is then fastened to the first shim, and so on. In this manner, a gradual damping can be undertaken. The further shims are mounted on the respective previous shim preferably in an integrally bonded manner, for example with an adhesive, such as a silicone rubber. In one embodiment, the shims themselves are designed as sheet metal strips. In another embodiment, all of the shims are of identical design. In other embodiments in turn, at least one shim is formed differently from another shim in respect of the shape thereof and/or the material thereof. For example, shims having a different thickness can be used. Yet another embodiment makes provision for the shims to have recesses and/or formations, for example through openings or other geometries.

In addition, an embodiment makes provision for the damping device to be arranged wound at least partially in a circumferential direction around the stator such that said damping device surrounds the stator at least partially in the circumferential direction. The shims may also be oriented axially. The best results for damping can be achieved with a shim arranged in the circumferential direction. A dimension of the shim in the circumferential direction is larger here than a dimension in the axial direction; that is to say the shim is larger in the longitudinal direction than in the transverse direction. The winding is arranged in such a manner that the shim does not overlap itself. In another embodiment, overlapping is provided. The overlapping is formed, for example, in a simple manner, wherein the shim overlaps itself at least partially once. In another embodiment, the shim overlaps itself several times.

It is also provided in an embodiment that a plurality of damping devices are provided. A damping device can consist of one shim or a plurality of shims or can comprise a plurality of shims. The shims are connected to one another in an integrally bonded manner, for example. The shims are arranged in layers one above the other here. In addition, a plurality of damping devices can be provided, wherein the damping devices can be designed identically or differently.

Accordingly, one embodiment makes provision for the plurality of damping devices to be arranged parallel to and/or in series with one another. The damping devices are preferably arranged in the circumferential direction. In order, for example, to realize full encasing, the shims/damping devices can be arranged one behind another in the circumferential direction. In other embodiments, the damping devices/shims are arranged next to one another in the circumferential direction, i.e. parallel.

The method according to the invention having the features of the corresponding main claim has the advantage over the prior art that, in the case of a method for producing and/or for operating an electric machine for converting mechanical energy into electrical energy or vice versa, in particular in the case of a generator, such as a claw-pole generator and/or a belt-driven starter generator, in which machine a magnetic flux is produced between at least two conductive components during the conversion, in particular in which a magnetic flux is produced between at least one rotor and at least one associated stator during the conversion, wherein a damping device in the manner of a shim is arranged in an integrally bonded manner on at least one of the two components without clamping, that is to say without clamping with another component, or between adjacent components, in order to reduce a magnetic noise, the magnetic noises are reduced. Without clamping within the context of the present invention includes in particular an arrangement in which a shim is arranged without clamping with another component or between components, such as the end plate and the stator. Clamping with other components or between other components is therefore dispensed with. In one embodiment, the damping device is mounted without contact with adjacent components. In this case, the shim or the damping device, at least during the mounting, does not touch any further components apart from the stator. Without contact does not include brief contact, for example in the event of continuous or repeated movements of parts with respect to one another, in which brief contact occurs between shim and, for example, the end plate. Without contact refers to the state during the mounting of the shim. In a further embodiment, the connection of the clamping device with a connecting means takes place exclusively by mounting the connecting means between the damping device and a single component, preferably the stator. A further connection of the damping device by means of a connecting means, in particular an integrally bonded connecting means, to a further component does not take place. In addition, retrospective mounting of damping devices on an existing electric machine is possible. The shims, here in the form of sheet metal strips, are mounted or adhesively bonded, oriented in the circumferential direction, on the stator in an integrally bonded manner, for example with a silicone rubber. A plurality of shims can be mounted on the stator or on the previous shim simultaneously, for example as an assembly, or successively.

The use according to the invention having the features of the corresponding main claim has the advantage over the prior art that at least one damping device in the manner of a shim, in particular an above-described damping device, for reducing noise and/or for damping a magnetic flux between two components in an electric machine in which mechanical energy is converted into electrical energy or vice versa, in particular in the case of a generator, such as a claw-pole generator and/or a belt-driven starter generator, is used according to the description above in order thereby to bring about damping of magnetic noise. The damping device is mounted on the stator in an integrally bonded manner, for example by means of adhesive bonding. The use known to date from the sphere of brake technology can thus be correspondingly transferred for the first time to the sphere of generators. In one embodiment, there is therefore a build up by layer on the laminated stator core, said build up providing the following layers in the sequence from the inside to the outside: a laminated stator core is followed by an adhesive layer or a layer of another adhesion promoter. This is followed by the damping device designed as a layer, here in the form of a shim or a plurality of shims. The plurality of shims are likewise formed in the manner of layers, either lying directly on one another or with intermediate layers, for example a respective layer of an adhesion promoter. The uppermost shim is then finally followed by a further layer of the damping device. The final layer is designed as a rubber coating or the like.

### BRIEF DESCRIPTION OF THE DRAWINGS

Exemplary embodiments of the invention are illustrated in the drawings and explained in more detail in the description below, in which:

FIG. 1 shows, in a cross-sectional view, an electric machine designed as a claw-pole generator,

FIG. 2 shows, in a perspective view, a detail of a claw-pole generator, and

FIG. 3 shows, in a cross-sectional view, a detail of a claw pole generator with a damping device.

### DETAILED DESCRIPTION

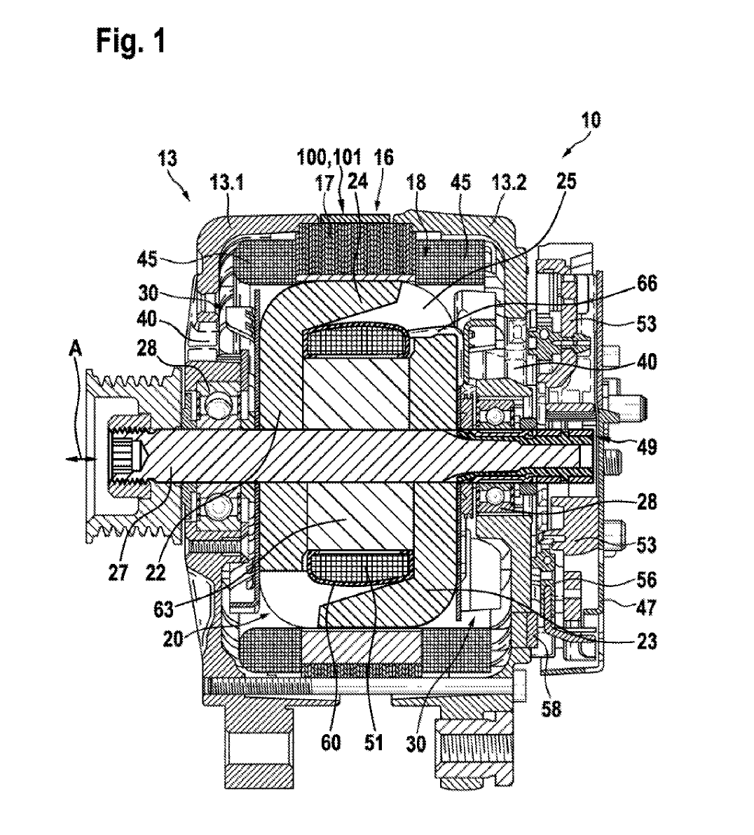

FIG. 1 shows, in a cross-sectional view, an electric machine 10 which is designed as a claw-pole generator, more precisely a cross section through an electric machine 10 which is designed in the embodiment illustrated here as a claw-pole generator for motor vehicles for converting mechanical energy into electrical energy. The electric machine 10 has a two-part housing 13 which comprises a first end plate 13.1 and a second end plate 13.2. The end plates 13.1 and 13.2 accommodate a “stator” 16 in them, said stator consisting of a stator core 17 which is substantially in the form of a circular ring, with (protruding) stator windings 18 being placed or pulled into slots in said stator which are directed radially inward and extend axially. Said ring-shaped stator 16, with its slotted surface pointing radially inward, surrounds a rotor 20, which is designed as a claw-pole rotor (not shown in detail here). The rotor 20 comprises a pole 22 designed as a claw pole, and a counter pole 23, which are also referred to as pole plates, claw-pole plates here, on the outer circumference of which pole fingers 24 and 25 (claw-pole fingers here, also called poles) extending in the axial direction are in each case arranged. In the mounted state, the claw pole 22 and the counter pole 23 are pressed against each other, and therefore their (claw) pole fingers 24 and 25 extending in the axial direction are arranged in an alternating manner over the circumference of the rotor 20. This results in magnetically required interspaces between the (claw) pole fingers 24 and 25 which are magnetized in an opposed direction and are called (claw) pole interspaces. The (claw) pole fingers have a radially outer surface facing an inner side of the stator. Depressions can be provided in said surface. The rotor 20 is mounted rotatably by means of a rotor shaft 27 and in each case one rolling bearing 28 located on in each case one side of the rotor shaft in the respective end plates 13.1 and 13.2, respectively.

The rotor 20 has two axial end surfaces, on which in each case one fan 30 is fastened. Said fan 30 consists substantially of a plate-like or disk-shaped section, from which fan blades emanate. The fan 30 serves the purpose of enabling air exchange between the outer side of the electric machine 10 and the interior of the electric machine 10 via openings 40 in the end plates 13.1 and 13.2 in order to implement air cooling. For this purpose, the openings 40 are provided substantially at the axial ends of the end plates 13.1 and 13.2, via which cooling air is sucked into the interior of the electric machine 10 by means of the fans 30. Said cooling air is accelerated radially outward by the rotation of the fans 30 such that said cooling air can pass through a winding overhang 45 which is permeable to cooling air. By means of this effect, the winding overhang 45 is additionally cooled. The cooling air, once it has passed through the winding overhang 45 or once it has flowed around the winding overhang 45, passes outward in the radial direction through the openings.

A protective cap 47 which protects various components of the rotor 20 from environmental influences and dirt is illustrated on the right-hand side in FIG. 1. The protective cap 47 covers a “slip ring assembly” 49 which serves to supply an exciting winding 51 with exciting current. A heat sink 53 is arranged around said slip ring assembly 49, said heat sink acting here as a positive heat sink. The end plate 13.2 acts as a “negative heat sink”. A connection plate 56 is arranged between the end plate 13.2 and the heat sink 53 and serves the purpose of connecting negative diodes 58 arranged in the end plate 13.2 and positive diodes (not shown here) in the heat sink 53 to one another and thus of representing a bridge circuit which is known per se.

The coil carrier 60 is arranged radially outside a pole core 63. The coil carrier 60 has the task of insulating the exciting winding 51 both with respect to the (claw) pole plates 22 and 23 and, within the scope of the premanufacturing, as a form-shaping element, very particularly after the winding operation with regard to the exciting winding wire has ended. The coil carrier 60 is pushed here with two connection conductors 66 axially over the pole core 63 and subsequently fixed axially between the two (claw) pole plates 22 and 23. Furthermore, the (claw) pole fingers 24 and 25 engage over the exciting winding 51 and thus form, radially outward, a type of cage which prevents the exciting winding 51 from being impermissibly radially displaced. The pole core 63 can also be subdivided axially into two sections which are molded onto the (claw) pole plates 22 and 23. A pole core length is calculated here from the total of the individual sections of the pole cores.

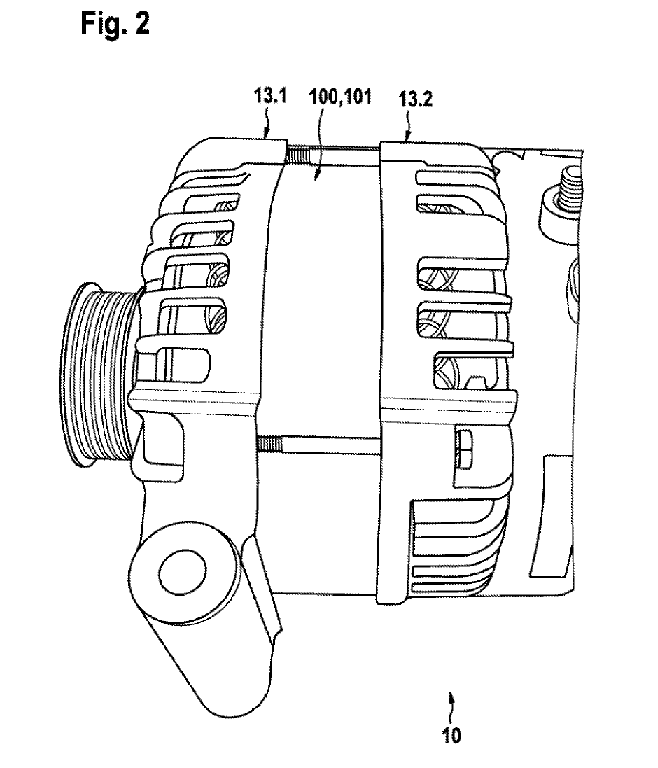

FIG. 2 shows, in a perspective view, a detail of a claw-pole generator. Between the two end plates 13.1 and 13.2, a damping device 100 designed as a shim 101 is arranged in a manner recessed in relation to said end plates. In the exemplary embodiment according to FIG. 2, the damping device 100 comprises a single shim 101. The shim 101 is designed as a thin sheet metal strip which is arranged in the circumferential direction on the stator 16 in an integrally bonded manner, adhesively bonded here by means of a silicone rubber. The sheet metal strip in the axial direction fills the clearance formed between the end plates 13.1 and 13.2. In the circumferential direction, the shim 101 winds around the entire stator 16, and therefore the latter is completely covered outward in the circumferential direction by the shim 101 in the region of the clearance. The shim 101, as illustrated here, is preferably produced from a different material than the end plates 13.1 and 13.2, namely from a metallic sheet metal material. The shim 101 is firmly bonded on the stator 16 before the two end plates 13.1 and 13.2 are connected. The orientation and additional fixing of the shim 101 or of the shims 101 can occur in a contact region between the shim 101 and the end plates 13.1 and/or 13.2. Clamping with the end plates 13.1 and/or 13.2 does not take place here.

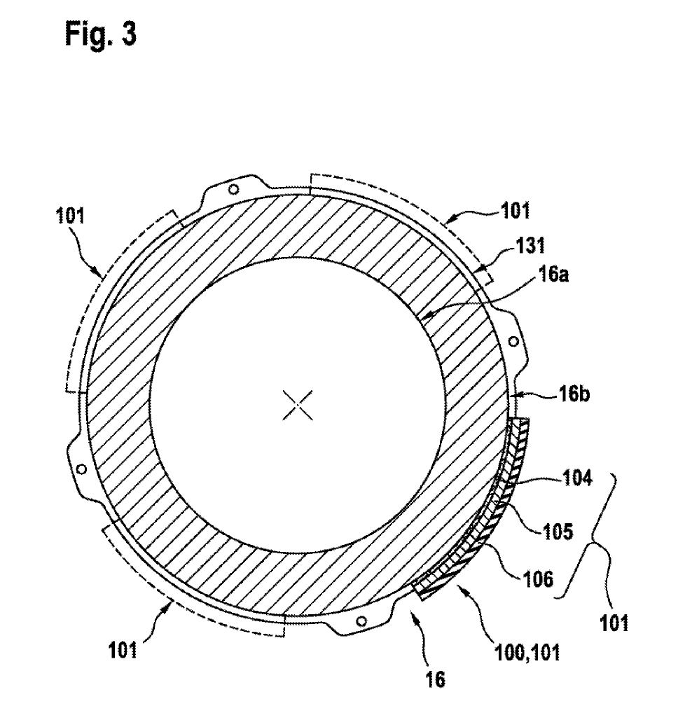

FIG. 3 shows, in a cross-sectional view, a detail of a claw-pole generator with a damping device 100. A damping device 100 is provided on the outer circumference of the stator 16, which has a stator inside diameter 16a and a stator outside diameter 16b and is therefore of annular design. The damping device 100 is designed in the manner of a plurality of shims 101, wherein the number of the shims 101 can be selected as desired. The stator 16 is surrounded in the axial direction by two end plates 13.1 and 13.2 which are spaced apart axially from each other, and therefore access to the stator 16 is possible. The damping device 100 and the shims 101 are provided in the region between the end plates 13.1 and 13.2. The shim 101 is illustrated by way of example in more detail at the bottom on the right. The shim 101 comprises, from the inside outward starting from the stator 16, an adhesive layer 104 which is designed as an adhesive, for example composed of silicone rubber or another suitable material. This is followed by metal, a sheet or a sheet metal strip 105. Optionally, as illustrated here, the sheet metal strip 105 is provided with a rubber coating or a rubber layer 106. The latter covers the sheet metal strip 105 to the outside. The shim 101 is matched to the outer contour of the stator 16. In the exemplary embodiment illustrated here, the shim 101 nestles against the outer contour of the stator 16 approximately in the shape of a segment of the circle. The adhesive layer 104 covers the entire side of the sheet metal strip 105 that faces the stator 16, and therefore said sheet metal strip is arranged on the stator 16 or on the outer surface thereof in a securely adhering manner. Adhesive layer 104, sheet metal strip 105 and rubber coating 106 are identically curved and in particular have the same curvature as the associated outer surface of the stator 16. The respective surfaces of stator 16, adhesive layer 104, sheet metal strip 105 and rubber coating are arranged as concentric (segments) of a circle with respect to one another. In the exemplary embodiment illustrated here, three further shims 101 are provided. The latter are arranged spaced apart from one another on the circumference of the stator 16. The shims 101 are adhesively bonded in the manner of a segment of a circle or of a ring on the outer surface of the stator 16 in a manner nestling thereagainst. In particular, the shims 101 are matched to the outer contour of the stator 16 in such a manner that air is not trapped between stator 16 and shim 101.

1. An electric machine (10) for converting mechanical energy into electrical energy or vice versa, the electric machine comprising at least two conductive components, between which there is a magnetic flux during the conversion of mechanical energy into electrical energy or vice versa, characterized in that a damping device (100) in the manner of a shim (101) is arranged in an integrally bonded manner on at least one of the two components without clamping, in order to reduce a magnetic noise.

2. The electric machine (10) as claimed in claim 1, characterized in that the one of the two components on which the damping device (100) is arranged is a stator (16).

3. The electric machine (10) as claimed in claim 2, characterized in that the damping device (100) is adhesively bonded on the stator (16) by means of at least one adhesive (104).

4. The electric machine (10) as claimed in claim 1, characterized in that the damping device (100) is of multilayered design.

5. The electric machine (10) as claimed in claim 2, characterized in that the damping device (100) is wound at least partially in a circumferential direction around the stator (16) such that said damping device surrounds the stator (16) at least partially in the circumferential direction.

6. The electric machine (10) as claimed in claim 1, characterized in that a plurality of damping devices (100) are provided.

7. The electric machine (10) as claimed in claim 6, characterized in that the plurality of damping devices (100) are arranged parallel to or in series with one another.

8. A method for producing and/or for operating an electric machine (100) for converting mechanical energy into electrical energy or vice versa, in which machine a magnetic flux is produced between at least two conductive components during conversion of mechanical energy into electrical energy or vice versa, characterized in that a damping device (100) in the manner of a shim (101) is arranged in an integrally bonded manner on at least one of the two components without clamping, in order to reduce a magnetic noise.

9. (canceled)

10. The method as claimed in claim 8 wherein the electric machine is a claw-pole generator and/or a belt-driven starter generator.

11. The method as claimed in claim 8 wherein the at least two conductive components include at least one rotor (20) and at least one associated stator (16).

12. The method as claimed in claim 8 wherein the damping device (100) is arranged in an integrally bonded manner on at least one of the two components without clamping with another component, or between adjacent components, in order to reduce a magnetic noise.

13. The electric machine as claimed in claim 1 wherein the electric machine is a claw-pole generator and/or a belt-driven starter generator.

14. The electric machine as claimed in claim 1 wherein the at least two conductive components include at least one rotor (20) and at least one associated stator (16).

15. The electric machine as claimed in claim 1 wherein the damping device (100) is arranged in an integrally bonded manner on at least one of the two components without clamping with another component, or between adjacent components, in order to reduce a magnetic noise.

16. The electric machine (10) as claimed in claim 1, characterized in that the damping device (100) is in the form of a multilayer composite material.

17. The electric machine (10) as claimed in claim 16, characterized in that the damping device (100) is wound at least partially in a circumferential direction around the stator (16) such that said damping device surrounds the stator (16) at least partially in the circumferential direction.
